(19) United States
(12) Patent Application Publication
(10) Pub. No.: US 2024/0414073 A1
(43) Pub. Date: Dec. 12, 2024

(54) Data Collection Method And Device

(71) Applicant: VIVO MOBILE COMMUNICATION CO., LTD., Dongguan (CN)

(72) Inventors: Chenglu Jia, Dongguan (CN); Yuanyuan Wang, Dongguan (CN); Bule Sun, Dongguan (CN); Zixun Zhuang, Dongguan (CN)

(21) Appl. No.: 18/812,729

(22) Filed: Aug. 22, 2024

Related U.S. Application Data
(63) Continuation of application No. PCT/CN2023/077389, filed on Feb. 21, 2023.

(30) Foreign Application Priority Data
Feb. 23, 2022 (CN) 202210170204.4

(51) Int. Cl. H04L 43/06; H04W 24/02; H04W 72/0446; H04W 72/0453; H04W 72/1268

(52) U.S. Cl. CPC H04L 43/06; H04W 24/02; H04W 72/0446; H04W 72/0453; H04W 72/1268

(57) ABSTRACT

A data collection method includes receiving, by a first communication device, first information from a second communication device; and performing, by the first communication device, data collection based on the first information, and training an artificial intelligence (AI) model based on collected data.

### CROSS-REFERENCE TO RELATED APPLICATIONS

This application is a Bypass Continuation application of International Patent Application No. PCT/CN2023/077389, filed Feb. 21, 2023, and claims priority to Chinese Patent Application No. 202210170204.4, filed Feb. 23, 2022, the disclosures of which are hereby incorporated by reference in their entireties.

### BACKGROUND OF THE INVENTION

### Field of the Invention

This application pertains to the field of communication technologies, and in particular, to a data collection method and a device.

### Description of Related Art

Artificial intelligence (AI) is currently widely used in various fields. AI is integrated into the field of wireless communication, to significantly improve a throughput, reduced a delay, and increase user capacity. However, current research and use of an AI model in the field of wireless communication are mainly focused on offline learning and deployment stages. Consequently, accuracy of an AI model prediction result is low, and it is difficult to meet a communication requirement.

### SUMMARY OF THE INVENTION

According to a first aspect, a data collection method is provided, including: A first communication device receives first information from a second communication device. The first communication device performs data collection based on the first information, and trains an AI model based on collected data.

According to a second aspect, a data collection method is provided, including: A second communication device sends third information to a first communication device. The third information is used to assist the first communication device in performing data collection and training an AI model based on collected data.

According to a third aspect, a terminal is provided. The terminal includes a processor and a memory, the memory stores a program or an instruction executable on the processor, and when the program or the instruction is executed by the processor, the steps of the method according to the first aspect or the second aspect are implemented.

According to a fourth aspect, a network-side device is provided. The network-side device includes a processor and a memory, the memory stores a program or an instruction executable on the processor, and when the program or the instruction is executed by the processor, the steps of the method according to the first aspect or the second aspect are implemented.

According to a fifth aspect, a data collection system is provided, including: a terminal and a network-side device. The terminal may be configured to perform the steps of the method according to the first aspect, and the network-side device may be configured to perform the steps of the method according to the second aspect.

According to a sixth aspect, a non-transitory readable storage medium is provided. The non-transitory readable storage medium stores a program or an instruction, and when the program or the instruction is executed by a processor, the steps of the method according to the first aspect or the steps of the method according to the second aspect are implemented.

According to a seventh aspect, a chip is provided. The chip includes a processor and a communication interface. The communication interface is coupled to the processor, and the processor is configured to run a program or an instruction, to implement the steps of the method according to the first aspect or the steps of the method according to the second aspect.

According to an eighth aspect, a computer program/program product is provided. The computer program/program product is stored in a non-transitory storage medium, and the program/program product is executed by at least one processor, to implement the steps of the method according to the first aspect or the steps of the method according to the second aspect.

### BRIEF DESCRIPTION OF THE DRAWINGS

FIG. 1 is a schematic diagram of a wireless communication system according to an embodiment of this application;

FIG. 2 is a schematic flowchart of a data collection method according to an embodiment of this application;

FIG. 3 is a schematic flowchart of a data collection method according to an embodiment of this application;

FIG. 4 is a schematic diagram of a structure of a first communication device according to an embodiment of this application;

FIG. 5 is a schematic diagram of a structure of a second communication device according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network-side device according to an embodiment of this application.

### DESCRIPTION OF THE INVENTION

The following clearly describes the technical solutions in embodiments of this application with reference to the accompanying drawings in embodiments of this application. Apparently, the described embodiments are some but not all of the embodiments of this application. All other embodiments obtained by a person of ordinary skill in the art based on embodiments of this application shall fall within the protection scope of this application.

The terms “first”, “second”, and the like in the specification and claims of this application are used to distinguish between similar objects instead of describing a specific order or sequence. It should be understood that, the terms used in such a way is interchangeable in proper circumstances, so that embodiments of this application can be implemented in an order other than the order illustrated or described herein. Objects classified by “first” and “second” are usually of a same type, and the number of objects is not limited. For example, there may be one or more first objects. In addition, in the description and claims, “and/or” represents at least one of connected objects, and a character “/” generally represents an “or” relationship between associated objects.

It should be noted that technologies described in embodiments of this application are not limited to a long term evolution (LTE)/LTE-Advanced (LTE-A) system, and may further be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), and another system. The terms “system” and “network” in embodiments of this application may be used interchangeably. The technologies described can be applied to both the systems and the radio technologies mentioned above as well as to another system and radio technology. A new radio (NR) system is described in the following description for illustrative purposes, and the NR terminology is used in most of the following description, although these technologies can also be applied to applications other than the NR system application, such as a 6^{th} generation (6G) communication system.

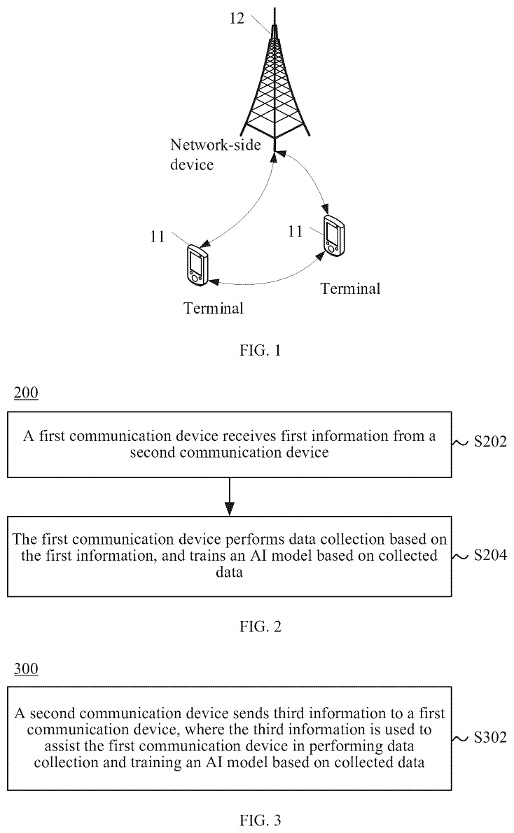

FIG. 1 is a block diagram of a wireless communication system to which an embodiment of this application may be applied. The wireless communication system includes terminals 11 and a network-side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, or the like. It should be noted that a specific type of the terminal 11 is not limited in embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (Wi-Fi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. As long as a same technical effect is achieved, the base station is not limited to a specified technical term. It should be noted that, in embodiments of this application, only a base station in an NR system is used as an example, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), centralized network configuration (CNC), a network repository function (NRF), a network exposure function (NEF), a local NEF (L-NEF), a binding support function (BSF), an application function (AF), or the like. It should be noted that, in embodiments of this application, only a core network device in an NR system is used as an example for description, and a specific type of the core network device is not limited.

With reference to the accompanying drawings, the following describes in detail a data collection method provided in embodiments of this application by using some embodiments and application scenes thereof.

As shown in FIG. 2, an embodiment of this application provides a data collection method 200. The method can be executed by a first communication device. In other words, the method can be executed by software or hardware installed on the first communication device. The method includes the following steps.

S202: The first communication device receives first information from a second communication device.

In various embodiments of this application, the first communication device may be a terminal, and the second communication device may be a network-side device; or the first communication device may be a first terminal, and the second communication device may be a second terminal; or the first communication device may be a first network-side device, and the second communication device may be a second network-side device. The network-side device mentioned in each of the examples, such as the first network-side device and the second network-side device, may be a core network device, an access network device, or a combination of a core network device and an access network device. The core network device can include a network data analytics function (NWDAF), a location management function (LMF), or a neural network processing node, or the like. The access network device can include a base station, a newly defined neural network processing node, or the like.

S204: The first communication device performs data collection based on the first information, and trains an AI model based on collected data.

The data collection is used for online learning of an AI model, and the AI model is used for a target communication service.

The first information is first indication information, and the first indication information is used to indicate the first communication device to perform data collection. This embodiment is applicable to a situation in which the first communication device is a terminal and the second communication device is a network-side device. The network-side device can indicate the terminal to perform data collection by using the first indication information. Most of the subsequent embodiments are described by taking the first information as the first indication information as an example.

The first information may alternatively be first permission information, and the first permission information is used to allow to perform data collection on the first communication device. This embodiment is applicable to a situation in which the first communication device is a network-side device and the second communication device is a terminal. In this embodiment, the network-side device can send user permission request information for data collection to the terminal. The terminal feeds back the first permission information (that is, user authorization information) to the network side, to indicate whether a user authorizes the network-side device to perform data collection on the terminal.

The AI model may be used to predict the target communication service, for example, predict a location of the terminal, or predict channel quality. It can be understood that data collected by the first communication device is data related to the target communication service. In this way, the AI model can perform online learning based on the collected data to improve prediction accuracy of the target communication service.

Optionally, after S204, the first communication device may also send the collected data to the second communication device. In this way, the second communication device may train the AI model based on the received data. The AI model may be deployed on the second communication device side. It can be understood that data collection performed by the first communication device may be a continuous process. In this way, the AI model may continuously predict the target communication service, and may also continuously perform iterative training based on the data collected by the first communication device. This is helpful to improve subsequent prediction accuracy and improve communication system performance.

Optionally, the AI model may be deployed on the first communication device side.

According to the data collection method provided by this embodiment of this application, the first communication device receives the first information from the second communication device. The first communication device performs data collection based on the first information. The data collection is used for online learning of the AI model, and the AI model is used for the target communication service. Because the AI model may perform online learning based on the collected data, it is helpful to improve the prediction accuracy of the AI model and improve the communication system performance.

This embodiment of this application takes into account that a wireless environment is constantly changing, and a fixed AI model obtained through offline training will gradually fail in a dynamic environment. The AI model needs to continuously learn new environment knowledge to improve its own adaptability. The data collection method provided by this embodiment of this application supports online learning of the AI model, and can also ensure a delay and accuracy of online learning of the AI model from the perspective of a dataset.

Optionally, after the first communication device performs data collection based on the first information, the method further includes: The first communication device sends, to the second communication device, at least one of the following related to the collected data:

(1) The collected data, where the collected data may be used by the second communication device to iteratively train the AI model to improve the prediction accuracy of the AI model.

(2) Timestamp information corresponding to the data, such as collection time of each piece or group of data collected. This embodiment is suitable for an AI model for time series prediction. Through the foregoing timestamp information, it is helpful to improve the prediction accuracy of the AI model.

(3) An amount of reported data. For example, how many pieces of data are currently available. The amount of reported data is helpful for the second communication device rationally to use the collected data.

(4) Error information of the data, such as an error of currently collected data, including (a) channel state information, such as a signal to interference plus noise ratio (SINR), reference signal received power (RSRP), a bit error rate, a packet error rate, quality of service (QOS), channel quality indicator (CQI) information, and the like; (b) network environment information; and (c) mobility information.

(5) A type and a format of the data. This embodiment is helpful for the second communication device to correctly identify the collected data, avoid data an identification error, and reduce a data processing delay.

(6) A processing method of the data. This embodiment is helpful for the second communication device to use a corresponding processing method to process the collected data and reduce the data processing delay.

(7) A cell identity (ID) associated with the data, which may include a physical cell ID, a global cell ID, and a transmission and reception point (TRP) ID.

(8) A reference signal identifier associated with the data. This embodiment is helpful for the second communication device to promptly understand a source of data and the like.

(9) An identifier of the AI model associated with the data. This embodiment takes into account that the second communication device may deploy a plurality of AI models, and different AI models may require different data for training. Therefore, the collected data carries the identifier of the AI model, which is helpful for the second communication device to correctly use the collected data.

(10) A task identifier associated with the data. This embodiment takes into account that the second communication device may deploy tasks, and different tasks may require different data for training. Therefore, the collected data carries the task identifier, which is helpful the second communication device to correctly use the collected data.

(11) A device identifier associated with the data. The device identifier may be a first communication device identifier, a second communication device identifier or a third communication device identifier. The data collected by the first communication device may be associated with a third communication device. For example, the third communication device performs sending, receiving, processing, feedback, and the like.

(12) Device hardware state information, such as remaining available storage space and remaining power. This embodiment is helpful for to the second communication device to deploy a collection task of the first communication device, avoid impact on the first communication device due to data collection, and improve user experience.

Considering that data collection is a power-consuming thing with little profit, and may involve private information of the first communication device (terminal), such as a location, and even measurement of a reference signal may also be private, because a position can be inferred based on the measured reference signal through AI, the embodiment 200 may also include at least one of the following steps:

(1) The first communication device receives permission request information from the second communication device, where the permission request information is used to request permission to perform data collection on the first communication device.

For example, the first communication device is a terminal, the second communication device is a network-side device, and the network-side device obtains the permission to perform data collection on the terminal by using permission request information.

(2) The first communication device sends second information to the second communication device, where the second information is used to indicate whether the first communication device supports in performing data collection.

For example, the first communication device is a terminal, the second communication device is a network-side device, and the terminal indicates to the network-side device that the terminal supports in performing data collection.

It can be understood that, after receiving the permission request information, the terminal may indicate to the network-side device that the terminal supports in performing data collection; or if not receiving the permission request information, the terminal may directly indicate to the network-side device that the terminal supports in performing data collection.

It can be understood that the above (1) and (2) can be executed before S202 or after S202.

Optionally, that the first communication device sends second information to the second communication device includes: The first communication device sends the second information to the second communication device based on device state information and the user authorization information. The device state information includes at least one of the following of the first communication device: the device hardware state information, or external environment information. The user authorization information includes: whether the first communication device is authorized to perform data collection for the target communication service or the AI model. For example, the user authorization information indicates whether a user to which the terminal belongs is willing to perform data collection for a designated service or AI model training.

This embodiment is helpful for the second communication device (such as a network-side device) to select a reasonable first communication device (such as a terminal) to perform data collection, thereby improving user experience. The reasonable first communication device mentioned here can be, for example, a device with strong hardware equipment, a communication device whose external environment matches data required by the AI model, and a communication device authorized by the user to perform data collection.

Optionally, the device hardware state information includes at least one of the following: a sensor state, a battery state, or a storage state. The sensor state may include a type of a sensor, which is helpful for determining whether a specified type of data collection is supported; a capability of the sensor, which may affect quality of dataset collection. The battery state, such as remaining power and estimated remaining standby time, affects whether data collection can be completed. The storage state includes, such as, space used to store the collected data, and data amount.

Optionally, the external environment information includes at least one of the following: the network environment information or the mobility information. The external environment information may be information obtained by the terminal through measurement of an external environment by using a hardware device. The mobility information includes, such as, high speed and low speed.

The network environment information may include at least one of the following: a serving cell and network state information of the serving cells, such as a mobile network access method, the second generation mobile communication technology (2G), the third generation mobile communication technology (3G), the fourth generation mobile communication technology (4G), the fifth generation mobile communication technology (5G), and the like; information associated with channel quality, such as a line of sight (LOS) environment and a non line of sight (NLOS) environment; or noise and interference measurement information, such as a SINR.

Optionally, the request information includes at least one of the following:

(1) A type and a data format of data collection, such as a time domain channel matrix of a specific dimension. This embodiment is helpful for the first communication device to collect appropriate data.

(2) A service type related to data collection. This embodiment takes into account that if the first communication device (terminal) does not have relevant service requirements, the user may not be willing to perform data collection. This embodiment is helpful in selecting a suitable first communication device for performing data collection.

(3) An identifier of the AI model associated with data collection. This embodiment takes into account that the second communication device may deploy a plurality of AI models, and different AI models may require different data for training. Therefore, the second communication device may allow the first communication device to perform data collection for a required AI model.

(4) An error threshold related to the collected data, including an error of measurement and an error of a label. This embodiment is helpful for the first communication device to collect data reasonably, and is also helpful for the first communication device to achieve an accuracy requirement of data collection combined with a device capability (such as a sensor capability).

(5) Time of performing data collection, including start time, end time, and duration. This embodiment is helpful for the first communication device to collect data within appropriate time.

(6) Time of data reporting. This embodiment is helpful for the first communication device to determine time to report data in a timely manner to avoid conflicts with other data.

(7) An amount of the collected data, such as collecting N pieces of data, where N is a positive integer, or measuring in bits (Binary digit, bit), for example, how many megabytes (MB) of data.

(8) An access method related to the collected data, such as a mobile network (2G, 3G, 4G, or 5G), Wi-Fi.

(9) A time gap of performing data collection, such as a time gap between two adjacent samples.

(10) A processing method related to the collected data, such as transformation and compression.

(11) A labeling method related to the collected data, including but not limited to a label, a data type, timestamp information, and the like. For example, a same data sample is labeled as, if a measurement quantity is channel state information, including a label: location information, a data type: a new/old dataset, a timestamp of data collection, and the like.

(12) Reporting indicator of data collection. The reporting indicator is used to indicate whether the collected data is reported.

Optionally, based on the foregoing various embodiments, the first information includes at least one of the following:

(1) A task identifier associated with data collection, such as AI positioning.

(2) An identifier of the AI model associated with data collection, such as the AI model used for positioning.

(3) Time of performing data collection, including start time, end time, and duration.

(4) An amount of the collected data, such as collecting N pieces of data, where N is a positive integer, or measuring in bits, for example, how many MB of data.

(5) A type and a data format of data collection, such as a time domain channel matrix of a specific dimension.

(6) A time gap of performing data collection, such as a time gap between two adjacent samples.

(7) A processing method related to the collected data, such as transformation and compression.

(8) A labeling method related to the collected data, including but not limited to a label, a data type, timestamp information, and the like. For example, a same data sample is labeled as 1. If a measurement quantity is channel state information, labels include: location information, a data type: a new/old dataset, a timestamp of data collection, and the like.

(9) Reporting indicator of data collection. The reporting indicator is used to indicate whether the collected data is reported.

(10) A reference signal identifier associated with data collection. For example, the second communication device sends a reference signal, and the first communication device performs data collection based on the reference signal.

(11) Reference signal configuration information associated with data collection. The configuration information may include the reference signal identifier for data collection, such as a channel state information-reference signal (CSI-RS), a synchronization signal/physical broadcast channel signal block/synchronization signal block (SSB), a positioning reference signal (PRS). The configuration information may include configuration information of the reference signal for data collection, including time domain information, frequency domain information, space domain information, port information, quasi co-location information, precoding information, and the like. For example, the second communication device sends a reference signal, and the first communication device performs data collection based on the reference signal. In the foregoing two embodiments, there is a partial overlap between content included in the first information and content included in the permission request information. In practical application, it is possible to avoid overlapping of the content included in the first information and the content included in the permission request information, thereby saving signaling overheads.

Optionally, the first information further includes information used to indicate a data reporting type. The data reporting type includes at least one of the following: (1) An interleaved reporting type, where the interleaved reporting type includes that data collection and data reporting are performed in turn. (2) An aggregated reporting type, where the aggregated reporting type includes that collected data is reported after reaching a pre-configured amount of data. This embodiment is helpful for the first communication device to report by selecting an appropriate data reporting method.

Optionally, the data collected by the first communication device is reported independently. The first communication device performs data collection based on one or more reference signals, and identities IDs of the one or more reference signals are related to a task related to data collection or the AI model. For example, a reference signal A is defined for reporting location information collected by the terminal, and a reference signal B is defined for reporting sensor information collected by the terminal. These two types of information are used for different tasks or AI models. Optionally, the data collected by the first communication device and other data are reported in an aggregated manner, for example, location data collected by the terminal and CSI are reported in an aggregated manner.

Optionally, the first information further includes information used to indicate a reporting time type. The reporting time type includes at least one of the following: (1) An interleaved reporting time type, where the interleaved reporting time type includes that reporting is performed after K1 time units in which one data sample is collected, K1 is a gap between collection time and reporting time, and K1 is a positive number. (2) An aggregated reporting time type, where the aggregated reporting time type includes that reporting is performed after K2 time units in which a configured amount of data is collected, K2 is a gap between collection time and reporting time, and K2 is a positive number.

Optionally, the first information further includes information used to a reporting format, and the reporting format includes at least one of the following: quantization information, such as a bit of a floating-point number; or a quantization level.

Optionally, the first information further includes uplink transmission resource information allocated to the first communication device, and the uplink transmission resource information includes at least one of the following: time resource information, frequency resource information, antenna port information, or beam indication information. This embodiment is helpful for the first communication device to report by using an appropriate transmission resource.

Optionally, the start time of data collection is determined by at least one of the following: (1) N1 time units before the AI model starts online learning; (2) N2 time units after the AI model starts online learning; (3) N3 time units before the AI model ends online learning; or (4) N4 time units after the AI model ends online learning, where N1, N2, N3 and N4 are positive numbers.

It should be noted that the time units mentioned in the various embodiments of this application may include: a reference signal period, a prediction period, a timeslot, a half timeslot, a symbol (an OFDM symbol), a subframe, a radio frame, a millisecond, a second, and the like.

The data collection method according to this embodiment of this application is described above in detail with reference to FIG. 2. A data collection method according to another embodiment of this application is described in detail below with reference to FIG. 3. It can be understood that description of the second communication device is the same as that of the first communication device side in the method shown in FIG. 2, and therefore related description is appropriately omitted to avoid repetition.

FIG. 3 is a schematic flowchart of implementing a data collection method according to an embodiment of this application. The method may be applied to a second communication device. As shown in FIG. 3, the method 300 includes the following steps.

S302: The second communication device sends third information to a first communication device, where the third information is used to assist the first communication device in performing data collection and training an AI model based on collected data.

The data collection is used for online learning of an AI model, and the AI model is used for a target communication service.

In this embodiment, the second communication device may be a network-side device, the first communication device may be a terminal, and the network-side device performs data collection.

In this embodiment, data collection is performed on the network-side device, including measurement, calculation, label annotating, and the like, but the network-side device may send some necessary information to the terminal. The information mainly includes configuration information of a reference signal associated with data collection, including: 1. an identifier of the reference signal used for data collection, such as a sounding reference signal (SRS), and/or 2. configuration information of the reference signal used for data collection, including: time domain information, frequency domain information, space domain information, port information, quasi co-location information, precoding information, and the like.

According to the data collection method provided by this embodiment of this application, the second communication device sends the third information to the first communication device. The third information is used to assist the first communication device in performing data collection, the data collection is used for online learning of the AI model, and the AI model is used for the target communication service. Because the AI model may perform online learning based on collected data, it is helpful to improve prediction accuracy of the AI model and improve communication system performance.

Optionally, as an embodiment, the third information includes at least one of the following: (1) a configured reference signal; (2) configuration information of a reference signal used for data collection; (3) an identifier of the AI model associated with the data; (4) a task identifier associated with the data; (5) a device identifier associated with the data; (6) external environment information of data collection; or (7) assistance information of data labeling. A role of the assistance information of data labeling is as follows. For example, in AI positioning, the network side obtains a measurement quantity based on a positioning reference signal, and also needs to obtain location information of the terminal as a label, that is, a label of a measurement quantity.

For a detailed description of content included in the third information, refer to the description of the corresponding content in the first information in the embodiment 200.

Optionally, as an embodiment, the method further includes at least one of the following: The second communication device sends permission request information to the first communication device. The permission request information is used to request permission to perform data collection on the first communication device. The second communication device receives fourth information from the first communication device. The fourth information is used to indicate whether the first communication device authorizes to perform data collection for the second communication device.

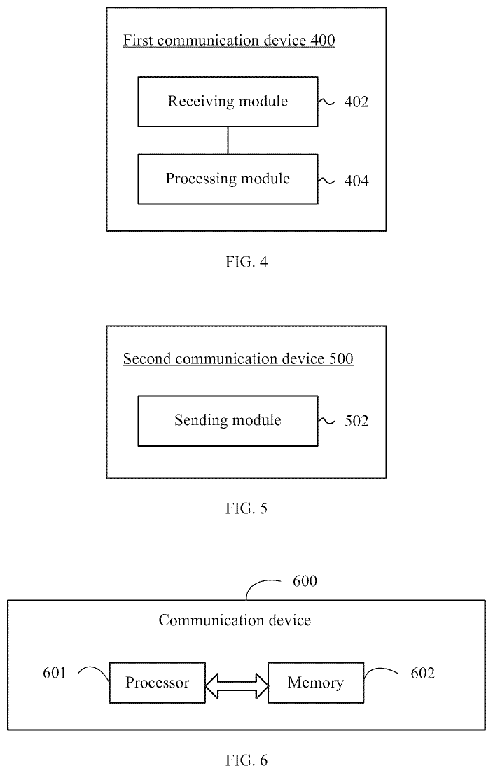

FIG. 4 is a schematic diagram of a structure of a first communication device according to an embodiment of this application. As shown in FIG. 4, the first communication device 400 includes the following modules:
a receiving module 402, configured to receive first information from a second communication device; and
a processing module 404, configured to perform data collection based on the first information, where the data collection is used for online learning of an AI model, and the AI model is used for a target communication service.

According to the first communication device provided in this embodiment of this application, the first communication device receives the first information from the second communication device. The first communication device performs data collection based on the first information. The data collection is used for online learning of the AI model, and the AI model is used for the target communication service. Because the AI model may perform online learning based on collected data, it is helpful to improve prediction accuracy of the AI model and improve communication system performance.

Optionally, as an embodiment, the first communication device further includes a sending module, configured to send, to the second communication device, at least one of the following related to the collected data: (1) the collected data; (2) timestamp information corresponding to the data; (3) an amount of reported data; (4) error information of the data; (5) external environment information of data collection; (6) a type and a format of the data; (7) a processing method of the data; (8) a cell ID associated with the data; (9) a reference signal identifier associated with the data; (10) an identifier of the AI model associated with the data; (11) a task identifier associated with the data; (12) a device identifier associated with the data; or (13) device hardware state information.

Optionally, as an embodiment, the receiving module is further configured to receive permission request information from the second communication device. The permission request information is used to request permission to perform data collection on the first communication device, and/or the first communication device further includes the sending module configured to send second information to the second communication device. The second information is used to indicate whether the first communication device supports in performing data collection.

For the second communication device 400 according to this embodiment of this application, reference may be made to the processes of the method 200 in the corresponding embodiment of this application, and the units/modules of the communication device 400 and other operations and/or functions described above are respectively intended to implement the corresponding processes in the method 200, with the same or equivalent technical effects achieved. For brevity, details are not described herein.

The first communication device in this embodiment of this application may be an electronic device, such as an electronic device with an operating system, or may be a component in an electronic device, such as an integrated circuit or chip. The electronic device may be a terminal or another device other than the terminal. For example, the terminal may include but is not limited to the types of terminals 11 listed above, and the another device may be a server, a network attached storage (NAS), or the like. This is not specifically limited in this embodiment of this application.

FIG. 5 is a schematic diagram of a structure of a second communication device according to an embodiment of this application. As shown in FIG. 5, the second communication device 500 includes the following module:
a sending module 502, configured to send third information to a first communication device, where the third information is used to assist the first communication device in performing data collection, the data collection is used for online learning of an AI model, and the AI model is used for a target communication service.

According to the second communication device provided in this embodiment of this application, the second communication device sends the third information to the first communication device. The third information is used to assist the first communication device in performing data collection, the data collection is used for online learning of the AI model, and the AI model is used for the target communication service. Because the AI model may perform online learning based on collected data, it is helpful to improve prediction accuracy of the AI model and improve communication system performance.

Optionally, as an embodiment, the third information includes at least one of the following: (1) a configured reference signal; (2) configuration information of a reference signal used for data collection; (3) an identifier of the AI model associated with the data; (4) a task identifier associated with the data; (5) a device identifier associated with the data; (6) external environment information of data collection; or (7) assistance information of data labeling. A role of the assistance information of data labeling is as follows. For example, in AI positioning, the network side obtains a measurement quantity based on a positioning reference signal, and also needs to obtain location information of the terminal as a label, that is, a label of a measurement quantity.

Optionally, as an embodiment, the sending module is further configured to send permission request information to the first communication device. The permission request information is used to request permission to perform data collection on the first communication device, and/or the second communication device further includes a receiving module configured to receive fourth information from the first communication device. The fourth information is used to indicate whether the first communication device authorizes to perform data collection for the second communication device.

For the second communication device 500 according to this embodiment of this application, reference may be made to the processes of the method 300 in the corresponding embodiment of this application, and the units/modules of the communication device 500 and other operations and/or functions described above are respectively intended to implement the corresponding processes in the method 300, with the same or equivalent technical effects achieved. For brevity, details are not described herein.

The first communication device provided in this embodiment of this application can implement the processes implemented in the method embodiment of FIG. 2, with the same technical effects achieved. To avoid repetition, details are not described herein again.

Optionally, as shown in FIG. 6, an embodiment of this application further provides a communication device 600, including a processor 601, a memory 602, and a program or an instruction stored in the memory 602 executable on the processor 601. For example, in a case that the communication device 600 is a terminal, when the program or the instruction is executed by the processor 601, the steps of the foregoing data collection method embodiment are implemented, with the same technical effects achieved. In a case that the communication device 600 is a network-side device, when the program or the instruction is executed by the processor 601, the steps of the foregoing data collection method embodiment are implemented, with the same technical effects achieved. To avoid repetition, details are not described herein again.

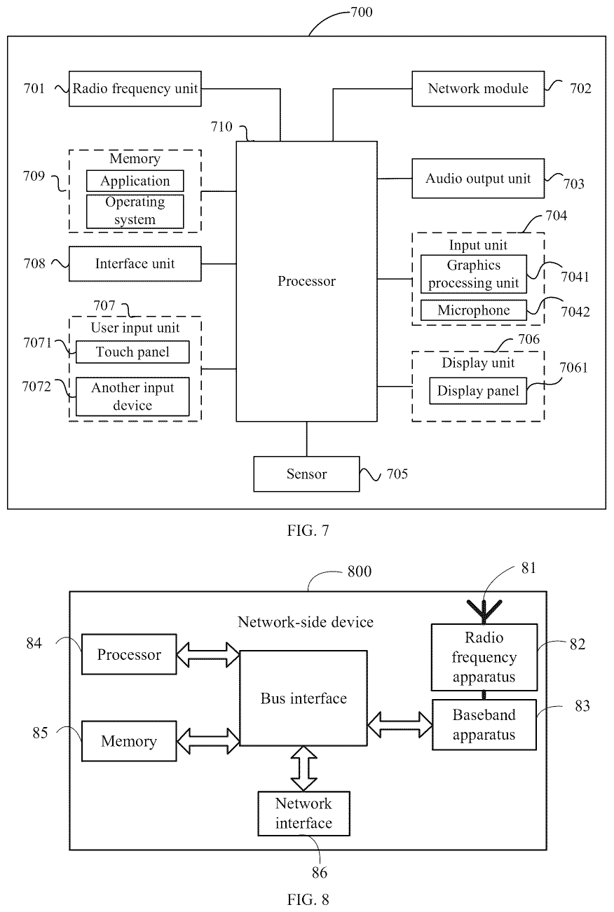

An embodiment of this application further provides a terminal, including a processor and a communication interface. The communication interface is configured to receive first information from a second communication device. The processor is configured to perform data collection based on the first information. The data collection is used for online learning of an AI model, and the AI model is used for a target communication service. The terminal embodiment is corresponding to the terminal side method embodiment. The implementation processes and implementations of the method embodiment can be applied to the terminal embodiment, with the same technical effects achieved. For example, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network-side device and then sends the downlink data to the processor 710 for processing. In addition, the radio frequency unit 701 may send uplink data to the network-side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory, or the memory 709 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The radio frequency unit 701 can be configured to receive the first information from the second communication device. The processor 710 can be configured to perform data collection based on the first information. The data collection is used for online learning of the AI model, and the AI model is used for the target communication service.

In this embodiment of this application, because the AI model may perform online learning based on collected data, it is helpful to improve prediction accuracy of the AI model and improve communication system performance.

The terminal 700 provided in this embodiment of this application further can implement the processes of the foregoing data collection method embodiment, with the same technical effects achieved. To avoid repetition, details are not described herein again.

An embodiment of this application further provides a network-side device, including a processor and a communication interface. The communication interface is configured to send third information to a first communication device. The third information is used to assist a first communication device in performing data collection, the data collection is used for online learning of an AI model, and the AI model is used for a target communication service. This network-side device embodiment is corresponding to the foregoing the network-side device method embodiment. The implementation processes and implementations of the foregoing method embodiment can be applied to the network-side device embodiment, with the same technical effects achieved.

Optionally, an embodiment of this application further provides a network-side device. As shown in FIG. 8, the network-side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network-side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 by using a bus interface, to invoke a program in the memory 85 to perform the operations of the network device shown in the foregoing method embodiment.

The network-side device may further include a network interface 86, and the interface is, for example, a common public radio interface (CPRI).

Optionally, the network-side device 800 in this embodiment of the present application further includes an instruction or a program that is stored in the memory 85 and executable on the processor 84. The processor 84 invokes the instruction or the program in the memory 85 to perform the method performed by the modules shown in FIG. 4 or FIG. 5, with same technical effects achieved. To avoid repetition, details are not described herein again.

An embodiment of this application further provides a non-transitory readable storage medium. The non-transitory readable storage medium stores a program or an instruction. When the program or the instruction is executed by a processor, the processes of the foregoing data collection method embodiment are implemented, and a same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, and the processor is configured to run a program or an instruction to implement the processes of the foregoing data transmission method embodiment, and a same technical effect can be achieved. To avoid repetition, details are not described herein again.

It should be understood that the chip mentioned in this embodiment of this application may also be referred to as a system-level chip, a system chip, a chip system, or a system-on-chip.

An embodiment of this application further provides a computer program/program product. The computer program/program product is stored in a non-transitory storage medium, and the computer program/program product is executed by at least one processor to implement the processes of the foregoing data transmission method embodiment, and a same technical effect can be achieved. To avoid repetition, details are not described herein again.

An embodiment of this application further provides a data collection system, including a terminal and a network-side device. The terminal may be configured to perform the steps of the data collection method, and the network-side device may be configured to perform the steps of the data collection method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in embodiments of this application is not limited to performing functions in the order shown or discussed, but may also include performing the functions in a basically simultaneous manner or in an opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a non-transitory storage medium (for example, a ROM/RAM, a floppy disk, or an optical disc), and includes several instructions for instructing a terminal (which may be a mobile phone, a computer, a server, an air conditioner, a network device, or the like) to perform the methods described in embodiments of this application.

Embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A data collection method, comprising:
receiving, by a first communication device, first information from a second communication device; and
performing, by the first communication device, data collection based on the first information, and training an artificial intelligence (AI) model based on collected data.

2. The method according to claim 1, wherein after the performing, by the first communication device, data collection based on the first information, the method further comprises: sending, by the first communication device to the second communication device, at least one of the following related to the collected data:
the collected data;
timestamp information corresponding to the data;
an amount of reported data;
error information of the data;
external environment information of data collection;
a type and a format of the data;
a processing method of the data;
a cell identity (ID) associated with the data;
a reference signal identifier associated with the data;
an identifier of the AI model associated with the data;
a task identifier associated the data;
a device identifier associated with the data; or
device hardware state information.

3. The method according to claim 1, wherein the method further comprises at least one of the following:
receiving, by the first communication device, permission request information from the second communication device, wherein the permission request information is used to request permission to perform data collection on the first communication device; or
sending, by the first communication device, second information to the second communication device, wherein the second information is used to indicate whether the first communication device supports in performing data collection.

4. The method according to claim 3, wherein the sending, by the first communication device, second information to the second communication device comprises:
sending, by the first communication device, the second information to the second communication device based on device state information and user authorization information, wherein
the device state information comprises at least one of the following of the first communication device: the device hardware state information or the external environment information; and
the user authorization information comprises: whether the first communication device is authorized to perform data collection for a target communication service or the AI model, wherein the AI model is used for the target communication service.

5. The method according to claim 4, wherein
the device hardware state information comprises at least one of the following: a sensor state, a battery state, or a storage state; and/or
the external environment information comprises at least one of the following: network environment information or mobility information;
wherein the network environment information comprises at least one of the following: a serving cell and network state information of the serving cell; information associated with channel quality; or noise and interference measurement information.

6. The method according to claim 3, wherein the permission request information comprises at least one of the following:
a type of data collection and a data format;
a service type related to data collection;
an identifier of the AI model associated with data collection;
an error threshold related to the collected data;
time of performing data collection;
time of data reporting;
an amount of the collected data;
an access method of data collection;
a time gap of performing data collection;
a processing method related to the collected data;
a labeling method related to the collected data; or
reporting indicator of data collection, wherein the reporting indicator is used to indicate whether the collected data is reported.

7. The method according to claim 1, wherein the first information comprises at least one of the following:
a task identifier associated with data collection;
an identifier of the AI model associated with data collection;
time of performing data collection;
an amount of the collected data;
a type of data collection and the data format;
a time gap of performing data collection;
a processing method related to the collected data;
a labeling method related to the collected data;
reporting indicator of data collection, wherein the reporting indicator is used to indicate whether the collected data is reported;
a reference signal identifier associated with data collection; or
reference signal configuration information associated with data collection.

8. The method according to claim 7, wherein the first information further comprises information used to indicate a data reporting type, and the data reporting type comprises at least one of the following:
an interleaved reporting type, wherein the interleaved reporting type comprises that data collection and data reporting are performed in turn; or
an aggregated reporting type, wherein the aggregated reporting type comprises that the collected data is reported after reaching a pre-configured amount of data.

9. The method according to claim 8, wherein
the data collected by the first communication device is reported independently, wherein the first communication device performs data collection based on one or more reference signals, and identities of the one or more reference signals are related to a task related to data collection or the AI model; or
the data collected by the first communication device and other data are reported in an aggregated manner.

10. The method according to claim 7, wherein the first information further comprises information used to indicate a reporting time type, and the reporting time type comprises at least one of the following:
an interleaved reporting time type, wherein the interleaved reporting time type comprises that reporting is performed after K1 time units in which one data sample is collected; or
an aggregated reporting time type, the aggregated reporting time type comprises that reporting is performed after K2 time units in which a configured amount of data is collected, wherein K1 and K2 are positive numbers.

11. The method according to claim 7, wherein the first information further comprises information used to indicate a reporting format, and the reporting format comprises at least one of the following:
quantitative information; or
quantitative level.

12. The method according to claim 7, wherein the first information further comprises uplink transmission resource information allocated to the first communication device, and the uplink transmission resource information comprises at least one of the following:
time resource information;
frequency resource information;
antenna port information; or
beam indication information.

13. The method according to claim 7, wherein start time of the data collection is determined by at least one of the following:
N1 time units before the AI model starts online learning;
N2 time units after the AI model starts online learning;
N3 time units before the AI model ends online learning; or
N4 time units after the AI model ends online learning, wherein
N1, N2, N3, and N4 are positive numbers.

14. The method according to claim 1, wherein
the first information is first indication information, and the first indication information is used to indicate the first communication device to perform data collection; and/or
the first information is first permission information, and the first permission information is used to allow to perform data collection on the first communication device.

15. A data collection method, comprising:
sending, by a second communication device, third information to a first communication device, wherein
the third information is used to assist the first communication device in performing data collection and training an artificial intelligence (AI) model based on collected data.

16. The method according to claim 15, wherein the third information comprises at least one of the following:
a configured reference signal;
configuration information of a reference signal used for data collection;
an identifier of the AI model associated with data;
a task identifier associated the data;
a device identifier associated with the data;
external environment information of data collection; or
assistance information of data labeling.

17. A terminal, comprising a processor and a memory, wherein the memory stores a program or an instruction executable on the processor, and the program or the instruction, when executed by the processor, causes the terminal to perform:
receiving first information from a second communication device; and
performing data collection based on the first information, and training an artificial intelligence (AI) model based on collected data.

18. A terminal, comprising a processor and a memory, wherein the memory stores a program or an instruction executable on the processor, and when the program or the instruction is executed by the processor, the steps of the data collection method according to claim 15 are implemented.

19. A network-side device, comprising a processor and a memory, wherein the memory stores a program or an instruction executable on the processor, and when the program or the instruction is executed by the processor, the steps of the data collection method according to claim 1 are implemented.

20. A network-side device, comprising a processor and a memory, wherein the memory stores a program or an instruction executable on the processor, and when the program or the instruction is executed by the processor, the steps of the data collection method according to claim 15 are implemented.
